(19) United States
(12) Patent Application Publication
(10) Pub. No.: US 2017/0155112 A1
(43) Pub. Date: Jun. 1, 2017

(54) NONAQUEOUS ELECTROLYTE SECONDARY BATTERY SEPARATOR

(71) Applicant: Sumitomo Chemical Company, Limited, Tokyo (JP)

(72) Inventor: Tomoaki OZEKI, Niihama-shi (JP)

(21) Appl. No.: 15/362,886

(22) Filed: Nov. 29, 2016

(30) Foreign Application Priority Data
Nov. 30, 2015 (JP) 2015-233933

(51) Int. Cl. H01M 2/16

(52) U.S. Cl. CPC H01M 2/1653; H01M 2/1686

(57) ABSTRACT

Provided is a nonaqueous electrolyte secondary battery separator which allows occurrence of an internal short circuit to sufficiently suppressed and accordingly allows a battery to be greatly safe, the nonaqueous electrolyte secondary battery separator including a porous film containing a polyolefin-based resin as a main component, the nonaqueous electrolyte secondary battery separator having tear strength of not less than 1.5 mN/μm, the tear strength being measured by the Elmendorf tear method, the nonaqueous electrolyte secondary battery separator exhibiting tensile elongation of a value A of not less than 0.5 mm from a time point when a load reaches a maximum load to a time point when the load decreases to 25% of the maximum load, according to a load-tensile elongation curve based on the right angled tear method.

This Nonprovisional application claims priority under 35 U.S.C. §119 on Patent Application No. 2015-233933 filed in Japan on Nov. 30, 2015, the entire contents of which are hereby incorporated by reference.

Technical Field

The present invention relates to a separator for a nonaqueous electrolyte secondary battery (hereinafter, referred to as a “nonaqueous electrolyte secondary battery separator”).

Background Art

Nonaqueous electrolyte secondary batteries (especially, lithium secondary batteries), which have a high energy density, have been widely used as batteries for use in personal computers, mobile phones, portable information terminals, and the like. Recently, nonaqueous electrolyte secondary batteries for use in cars have been developed.

As a separator used for a nonaqueous electrolyte secondary battery such as a lithium secondary battery, a microporous film containing a polyolefin as a main component has been used (Patent Literature 1).

Such a microporous film (i) has therein pores connected to one another and (ii) allows a liquid containing ions to pass therethrough from one surface to the other via the pores. Accordingly, the microporous film is suitable as a separator member for a battery in which passage of ions between a cathode and an anode occurs.

However, in recent years, with development of high-performance nonaqueous electrolyte secondary batteries, there have been demands for safer nonaqueous electrolyte secondary batteries.

Specifically, it is known that, in order to secure safety and productivity of a battery, it is effective to control tear strength of a separator which tear strength is measured by the Trouser tear method (in conformity with JIS K 7128-1) (Patent Literatures 2 and 5).

Furthermore, it is known that, in terms of, for example, handling of a film, it is effective to control tear strength of the film (Patent Literatures 3 and 4).

### CITATION LIST

### Patent Literature

### Patent Literature 1

Japanese Patent Application Publication, Tokukai, No. 2010-180341 (Publication date: Aug. 19, 2010)

### Patent Literature 2

Japanese Patent Application Publication, Tokukai, No. 2010-111096 (Publication date: May 20, 2010)

### Patent Literature 3

Japanese Patent Application Publication, Tokukai, No. 2013-163763 (Publication date: Aug. 22, 2013)

### Patent Literature 4

PCT International Publication, No. WO 2005/028553 (Publication date: Mar. 31, 2005)

### Patent Literature 5

PCT International Publication, No. WO 2013/054884 (Publication date: Apr. 18, 2013)

### SUMMARY OF INVENTION

### Technical Problem

However, a separator whose tear strength, measured by the Trouser tear method, is controlled does not allow a battery including the separator to be sufficiently safe. Therefore, in a case where the separator is given an impact, it may not possible to sufficiently suppress occurrence of an internal short circuit.

### Solution to Problem

In order to solve the above problem, the inventors of the present invention has focused attention on (i) tear strength of a porous film included in a separator which tear strength is measured by the Elmendorf tear method fin conformity with JIS K 7128-2) and (ii) an amount of tensile elongation exhibited by the porous film from a time point when a sample starts to be torn, according to a load-tensile elongation curve obtained by measuring tear strength of the porous film by the right angled tear method (in conformity with JIS K 7128-3), the tensile elongation having not been conventionally evaluated. The inventors of the present invention has found that, in a case where the tear strength and the tensile elongation have respective given values or more, the separator allows occurrence of an internal short circuit to be sufficiently suppressed and therefore allows a battery including the separator to be sufficiently safe. As a result, the inventors of the present invention have arrived at the present invention.

That is, the present invention includes the following inventions [1] through [4]:

[1]

A nonaqueous electrolyte secondary battery separator including a porous film containing a polyolefin-based resin as a main component,
the nonaqueous electrolyte secondary battery separator having tear strength of not less than 1.5 mN/μm, the tear strength being measured by the Elmendorf tear method fin conformity with JIS K 7128-2),

in measurement carried out by the Elmendorf tear method, a direction in which the porous film is torn being a TD direction,

the nonaqueous electrolyte secondary battery separator exhibiting tensile elongation of a value A of not less than 0.5 mm from a time point when a load reaches a maximum load to a time point when the load decreases to 25% of the maximum load, according to a load-tensile elongation curve obtained by measuring tear strength of the nonaqueous electrolyte secondary battery separator by the right angled tear method (in conformity with JIS K 7128-3),

in measurement carried out by the right angled tear method, a direction in which the porous film is stretched being an MD direction, and a direction in which the porous film is torn being the TD direction.

[2]

A nonaqueous electrolyte secondary battery laminated separator including:
a nonaqueous electrolyte secondary battery separator recited in [1]; and

a porous layer.

[3]

A nonaqueous electrolyte secondary battery member including:

a cathode;

a nonaqueous electrolyte secondary battery separator recited in [1] or a nonaqueous electrolyte secondary battery laminated separator recited in [2]; and

an anode,

the cathode, the nonaqueous electrolyte secondary battery separator or the nonaqueous electrolyte secondary battery laminated separator, and the anode being provided in this order.

[4]

A nonaqueous electrolyte secondary battery including:

a nonaqueous electrolyte secondary battery separator recited in [1] or a nonaqueous electrolyte secondary battery laminated separator recited in [2].

### Advantageous Effects of Invention

According to a nonaqueous electrolyte secondary battery separator in accordance with an embodiment of the present invention, it is possible to suppress occurrence of an internal short circuit caused by an external impact.

### BRIEF DESCRIPTION OF DRAWINGS

FIG. 1 is a view schematically illustrating a method of calculating, from a load-tensile elongation curve based on the right angled tear method, a value A of tensile elongation exhibited from a time point when a load reaches a maximum load to a time point when the load decreases to 25% of the maximum load.

FIG. 2 is a view illustrating load-tensile elongation curves, each based on the right angled tear method, obtained in Examples and Comparative Examples.

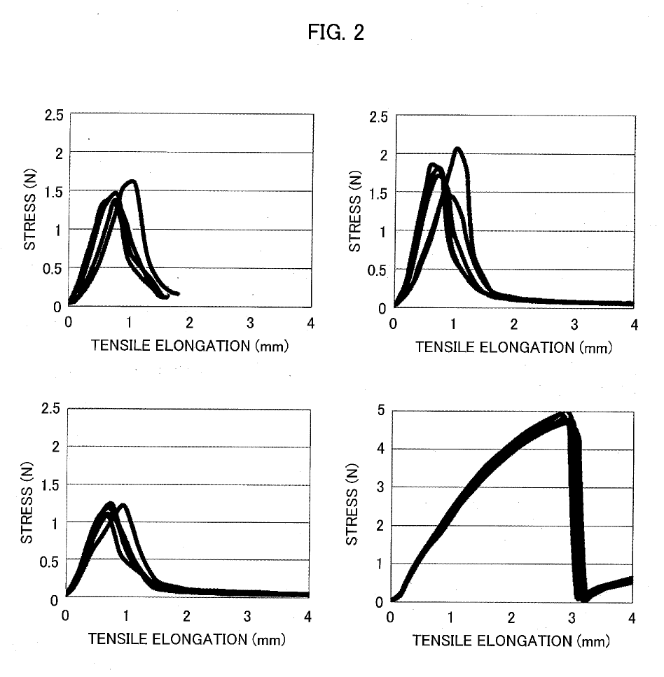

FIG. 3 is a perspective view schematically illustrating a measurement device, for an electrical conduction test by nail penetration, used in Examples and Comparative Examples.

### DESCRIPTION OF EMBODIMENTS

### Embodiment 1: Nonaqueous Electrolyte Secondary Battery Separator

### Embodiment 2: Nonaqueous Electrolyte Secondary Battery Laminated Separator

A nonaqueous electrolyte secondary battery separator in accordance with Embodiment 1 of the present invention includes a porous film containing a polyolefin-based resin as a main component, the nonaqueous electrolyte secondary battery separator having tear strength of not less than 1.5 mN/μm, the tear strength being measured by the Elmendorf tear method (in conformity with JIS K 7128-2), in measurement carried out by the Elmendorf tear method, a direction in which the porous film is torn being a TD direction, the nonaqueous electrolyte secondary battery separator exhibiting tensile elongation of a value A of not less than 0.5 mm from a time point when a load reaches a maximum load to a time point when the load decreases to 25% of the maximum load, according to a load-tensile elongation curve obtained by measuring tear strength of the nonaqueous electrolyte secondary battery separator by the right angled tear method (in conformity with JIS K 7128-3), in measurement carried out by the right angled tear method, a direction in which the porous film is stretched being an MD direction, and a direction in which the porous film is torn being the TD direction.

A laminated separator for a nonaqueous electrolyte secondary battery (hereinafter, referred to as a “nonaqueous electrolyte secondary battery laminated separator”) in accordance with Embodiment 2 of the present invention includes the nonaqueous electrolyte secondary battery separator in accordance with Embodiment 1 of the present invention and a porous layer.

[Porous Film]

A porous film in accordance with an embodiment of the present invention is a porous film containing a polyolefin-based resin as a main component. The porous film in accordance with an embodiment of the present invention is preferably a microporous film. That is, the porous film is preferably a film which (i) contains a polyolefin-based resin as a main component, (ii) has therein pores connected to one another, and (iii) allows a gas or a liquid to pass therethrough from one surface to the other. The porous film can be made up of a single layer or can be alternatively made up of a plurality of layers.

Note that the phrase “a porous film containing a polyolefin-based resin as a main component” means that a polyolefin-based resin component accounts for normally not less than 50% by volume, preferably not less than 90% by volume, more preferably not less than 95% by volume of an entire porous film. The polyolefin-based resin of the porous film preferably contains a high-molecular-weight component having a weight average molecular weight falling within a range of 5×10⁵ to 15×10⁶. Especially, the polyolefin-based resin preferably contains a high-molecular-weight component having a weight average molecular weight of not less than 1,000,000. This causes (i) an increase in strength of the entire porous film, that is, the entire nonaqueous electrolyte secondary battery separator and (ii) an increase in strength of the entire nonaqueous electrolyte secondary battery laminated separator including the porous film and a later described porous layer.

Examples of the polyolefin-based resin include high-molecular-weight homopolymers (such as polyethylene, polypropylene, and polybutene) and high-molecular-weight copolymers (such as an ethylene-propylene copolymer) which homopolymers and copolymers are each obtained by polymerizing ethylene, propylene, 1-butene, 4-methyl-1-pentene, 1-hexene, or the like. The porous film is made up of a layer containing one kind selected from those polyolefin-based resins and/or a layer containing two or more kinds selected from those polyolefin-based resins. In particular, a high-molecular-weight polyethylene-based resin which is mainly made of ethylene is preferable because such a polyethylene-based resin allows a flow of an excessive electric current to be prevented (shutdown) at a lower temperature. Note that the porous film can contain a component, other than the polyolefin-based resin, provided that the component does not hinder a function of the porous film.

The porous film has a Gurley air permeability normally of 30 sec/100 cc to 500 sec/100 cc, preferably of 50 sec/100 cc to 300 sec/100 cc. In a case where the porous film which has an air permeability falling within the above range is used as the nonaqueous electrolyte secondary battery separator or as a member of the nonaqueous electrolyte secondary battery laminated separator including a later described porous layer, the nonaqueous electrolyte secondary battery separator or the nonaqueous electrolyte secondary battery laminated separator achieves sufficient ion permeability.

In a case where the porous film is used as the nonaqueous electrolyte secondary battery separator, the porous film has a film thickness preferably of not more than 20 μm, more preferably of not more than 16 μm, still more preferably of not more than 11 μm, and preferably of not less than 4 μm, more preferably of not less than 6 μm. That is, the porous film has a film thickness preferably of not less than 4 μm and not more than 20 μm. In a case where the porous film is used as a member of the nonaqueous electrolyte secondary battery laminated separator including the porous film and a later described porous layer, the film thickness of the porous film is determined as appropriate in consideration of the number of layers of the nonaqueous electrolyte secondary battery laminated separator. Especially, in a case where a porous layer is formed on one side for both sides) of the porous film, the porous film has a film thickness preferably of 4 μm to 20 μm, more preferably of 6 μm to 16 μm.

In a case where the porous film is used as the nonaqueous electrolyte secondary battery separator, the porous film has a film thickness preferably of not less than 4 μm because such a porous film makes it possible to sufficiently prevent an internal short circuit due to, for example, breakage of a battery. Meanwhile, the porous film has a film thickness preferably of not more than 20 μm because such a porous film makes it possible to (i) prevent a deterioration, caused in a case where charge and discharge cycles are repeated, in (a) cathode and (b) rate characteristic and/or cycle characteristic, by preventing an increase in permeation resistance of lithium ions in the entire nonaqueous electrolyte secondary battery separator including the porous film and (ii) prevent an increase in size of a nonaqueous electrolyte secondary battery by preventing an increase in distance between the cathode and an anode.

In a case where the porous film is used as a member of the nonaqueous electrolyte secondary battery laminated separator including the porous film and a later described porous layer, the porous film has a film thickness preferably of not less than 4 μm because such a porous film makes it possible to sufficiently prevent an internal short circuit due to, for example, breakage of a battery. Meanwhile, the porous film has a film thickness preferably of not more than 20 μm because such a porous film makes it possible to (i) prevent a deterioration, caused in a case where charge and discharge cycles are repeated, in (a) cathode and (b) rate characteristic and/or cycle characteristic, by preventing an increase in permeation resistance of lithium ions in the entire nonaqueous electrolyte secondary battery laminated separator including the porous film and a later described porous layer and (ii) prevent an increase an size of a nonaqueous electrolyte secondary battery by preventing an increase in distance between the cathode and an anode.

In a case where the porous film is used as the nonaqueous electrolyte secondary battery separator and in a case where the porous film is used as a member of the nonaqueous electrolyte secondary battery laminated separator including the porous film and a later described porous layer, the porous film has a mass normally of 4 g/m² to 20 g/m², preferably of 4 g/m² to 12 g/m², more preferably of 5 g/m² to 10 g/m² in that such a porous film makes it possible to increase not only strength, a thickness, handleability, and a weight of the nonaqueous electrolyte secondary battery separator or the nonaqueous electrolyte secondary battery laminated separator but also a weight energy density and a volume energy density of a nonaqueous electrolyte secondary battery including the nonaqueous electrolyte secondary battery separator or the nonaqueous electrolyte secondary battery laminated separator.

The porous film has a porosity preferably of 30% by volume to 60% by volume, more preferably of 35% by volume to 55% by volume so that the porous film can retain an increased amount of an electrolyte and achieve a function of absolutely preventing (shutdown) a flow of an excessive electric current at a lower temperature.

In a case where the porous film has a porosity of lower than 30% by volume, a resistance of the porous film tends to be increased. In a case where the porous film has a porosity of higher than 60% by volume, mechanical strength of the porous film tends to be decreased.

Further, the porous film has pores each having a pore size preferably of not more than 0.3 μm, more preferably of not more than 0.14 μm so that, in a case where the porous film is used as the nonaqueous electrolyte secondary battery separator or a member of the nonaqueous electrolyte secondary battery laminated separator, the nonaqueous electrolyte secondary battery separator or the nonaqueous electrolyte secondary battery laminated separator can obtain sufficient ion permeability and prevent particles from entering a cathode or an anode.

The nonaqueous electrolyte secondary battery laminated separator in accordance with an embodiment of the present invention is preferably arranged such that a porous layer is formed on the porous film by a method later described. In this case, the porous film is more preferably subjected to a hydrophilization treatment before the porous layer is formed on the porous film, that is, before the porous film is coated with a coating solution later described. Subjecting the porous film to the hydrophilization treatment further improves coating easiness of the coating solution, and accordingly allows the porous layer which is more uniform to foe formed. This hydrophilization treatment is effective in a case where a solvent (disperse medium) contained in the coating solution has a high proportion of water. Specific examples of the hydrophilization treatment include publicly known treatments such as (i) a chemical treatment involving an acid, an alkali, or the like, (ii) a corona treatment, and (iii) a plasma treatment. Among these hydrophilization treatments, the corona treatment is more preferable because the corona treatment makes it possible to not only hydrophilize the porous film within a relatively short time period, but also hydrophilize only a surface and its vicinity of the porous film to leave an inside of the porous film unchanged in quality.

A method of producing the porous film is not limited to particular one, and a publicly known method can be employed. For example, the porous film can foe produced by (i) adding a pore-forming agent, such as calcium carbonate or a plasticizer, to a thermoplastic resin to form a film and then (ii) removing the pore-forming agent with use of an appropriate solvent.

Specifically, in a case where, for example, the porous film is produced from a polyolefin resin containing (i) an ultrahigh-molecular-weight polyethylene and (ii) a low-molecular-weight polyolefin having a weight average molecular weight of not more than 10,000, the porous film is preferably produced, in terms of production costs, by a method including the steps of:

(1) kneading (i) 100 parts by weight of a ultrahigh-molecular-weight polyethylene, (ii) 5 parts by weight to 200 parts by weight of a low-molecular-weight polyolefin having a weight average molecular weight of not more than 10,000, and (iii) 100 parts by weight to 400 parts by weight of a pore-forming agent, such as calcium carbonate, to obtain a polyolefin resin composition;

(2) forming a sheet with use of the polyolefin resin composition;

(3) removing the pore-forming agent from the sheet obtained in the step (2); and

(4) stretching the sheet obtained in the step (3).

Alternatively, a method disclosed in each Patent Literature cited above can be employed.

Alternatively, the porous film in accordance with an embodiment of the present invention can be produced by, specifically, a method including the steps of:

(1′) (i) mixing 100 parts by weight, in total, of ultrahigh-molecular-weight polyethylene powder and low-molecular-weight polyethylene wax (having, for example, a weight average molecular weight of 1,000) with 0.5 parts by weight of an antioxidant and 1.3 parts by weight of sodium stearate, (ii) adding calcium carbonate, having an average particle size of 0.1 μm, to a resultant mixture so that the calcium carbonate accounts for 36% by volume of a total volume of a mixture obtained by adding the calcium carbonate, (iii) mixing these compounds in a state of powder with use of a Henschel mixer, (iv) melt-kneading a resultant mixture with use of a twin screw kneading extruder, and then (v) causing the mixture to pass through a 200 to 300-mesh metal gauze, to obtain a polyolefin resin composition;

(2′) rolling the polyolefin resin composition with use of a pair of rollers each having a surface temperature of 150° C., and cooling the polyolefin resin composition in stages while stretching the polyolefin resin composition with use of other rollers rotating at a speed different from that of the pair of rollers, to prepare a single-layer sheet;

(3′) immersing the single-layer sheet in an aqueous hydrochloric solution (in which 4 mol/L of hydrochloric acid and 0.5% by weight of a non-ionic surfactant are blended) to remove the calcium carbonate; and

(4′) stretching the single-layer sheet obtained in the step (3′).

Note that the above production method can be arranged such that (i) another single-layer sheet is prepared in a way similar to that in the step (2′), (ii) the another single-layer sheet and the single-layer sheet prepared in the step (2′) are pressure-bonded to each other by heat with use of a pair of rollers so as to prepare a laminated sheet, and then (iii) the steps (3′) and (4′) are carried out with use of the laminated sheet instead of the single-layer sheet prepared in the step (2′). Note that, in terms of an improvement in tear strength and in value A of tensile elongation of the porous film, the step (3′) is preferably carried out with use of the single-layer sheet.

Note that, as the porous film in accordance with an embodiment of the present invention, a commercially-available film having the foregoing properties can also be used.

[Tear Strength Measured by Elmendorf Tear Method]

Tear strength measured by the Elmendorf tear method in an embodiment of the present invention (hereinafter, referred to as Elmendorf-tear-method-based tear strength) is measured in accordance with “JIS K 7128-2 Plastics-Film and sheeting-Determination of tear resistance—Part 2: Elmendorf method.” Details of measurement conditions and the like are as follows:

Device: digital Elmendorf tear tester (manufactured by Toyo Seiki Seisaku-Sho, SA-WP type);

Sample size: specimen form, having a rectangular shape, based on the Japanese Industrial Standards;

Conditions: swing angle of 68.4 degrees, the number of times of measurement n=5; and

A sample used for evaluation is cut out from a porous film, to be subjected to measurement, so that a direction in which the sample is to be torn during the measurement is at a right angle with respect to a direction in which the porous film has been conveyed during preparation of the porous film (hereinafter, a direction of the right angle will he referred to as a TD direction). Further, the measurement is carried out in a state where four through eight samples of the porous film are layered, and a value of a tear load thus measured is divided by the number of the samples so as to calculate tear strength of each of the samples. Thereafter, by dividing the tear strength of the each of the samples by a thickness of the each of the samples, tear strength T per micrometer of a thickness of the porous film is calculated.

That is, the tear strength T is calculated from the following expression:

T=(F/d)

where: T denotes tear strength (mN/μm);

F denotes a tear load (mN/film); and

d denotes a film thickness (μm/film).

The porous film in accordance with an embodiment of the present invention has Elmendorf-tear-method -based tear strength of not less than 1.5 mN/μm, preferably of not less than 1.75 mN/μm, more preferably of not less than 2.0 mN/μm, and preferably of not more than 10 mN/μm, more preferably of not more than 4.0 mN/μm. In a case where the porous film has Elmendorf-tear-method-based tear strength (tear direction: TD direction) of not less than 1.5 mN/μm, the porous film (i.e., the nonaqueous electrolyte secondary battery separator and the nonaqueous electrolyte secondary battery laminated separator including the porous film and a later described porous layer) causes an internal short circuit not to easily occur, even when being given an impact.

[Value A of Tensile Elongation Based on Right Angled Tear Method]

A value A of tensile elongation exhibited from a time point when a load reaches a maximum load to a time point when the load decreases to 25% of the maximum load, according to a load-tensile elongation curve based on the right angled tear method (hereinafter, referred to as a right-angled-tear-method-based tensile elongation value A) in an embodiment of the present invention is calculated from a load-tensile elongation curve created from a result of measuring tear strength in accordance with “JIS K 7128-3 Plastics-Film and sheeting-Determination of tear resistance—Part 3: Right angled tear method.”

Details of conditions for measuring tear strength by the right angled tear method are as follows;

Device: universal testing machine (manufactured by INSTRON, 5582 type);

Sample size: specimen form, based on the Japanese Industrial Standards;

Conditions: tension speed of 200 mm/min, the number of times of measurement n=5; and

A sample used for evaluation is cut out so that a direction in which the sample is to be torn is a TD direction. Note that, according to the right angled tear method, since a direction in which the sample is stretched is opposite to the direction in which the sample is torn, the direction in which the sample is stretched is an MD direction, and the direction in which the sample is torn is the TD direction. That is, the sample becomes longer in the MD direction than in the TD direction.

A load-tensile elongation curve is created from a result of the above measurement carried out by the right angled tear method. Next, from the load-tensile elongation curve, a right-angled-tear-method-based tensile elongation value A is calculated by the following method.

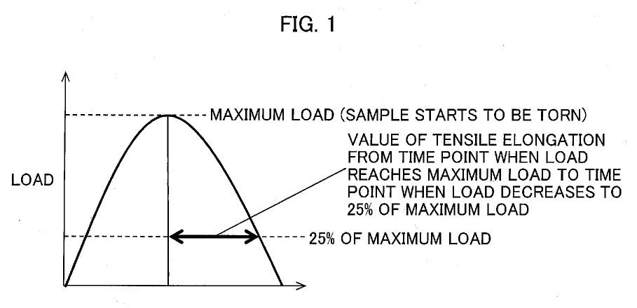

In the load-tensile elongation curve, a maximum load (load at a time point when the sample starts to be torn) is assumed to be X (N). A value obtained by multiplying X (N) by 0.25 is assumed to be Y (N). Further, in the load-tensile elongation curve, a value of tensile elongation from a time point when the load reaches X to a time point when the load decreases to Y is assumed to be A (mm) (see FIG. 1).

The porous film in accordance with an embodiment of the present invention has a right-angled-tear-method-based tensile elongation value A of not less than 0.5 mm, preferably of not less than 0.75 mm, more preferably of not less than 1.0 mm, and preferably of not more than 10 mm. In a case where the right-angled-tear-method-based tensile elongation value A is not less than 0.5 mm, the porous film (i.e., the nonaqueous electrolyte secondary battery separator and the nonaqueous electrolyte secondary battery laminated separator including the porous film and a later described porous layer) tends to allow sudden occurrence of a serious internal short circuit to be suppressed, even when being given an external impact.

[Control of Tear Strength and of Value A of Tensile Elongation]

As a method of improving the tear strength and the value A of the tensile elongation of the porous film in accordance with an embodiment of the present invention, (a) a method of improving uniformity of an inside of the porous film, (b) a method of reducing a proportion of a skin layer accounting for a surface of the porous film, (c) a method of reducing a difference in crystalline orientation between the TD direction and an MD direction of the porous film, or the like can be employed.

As the method of improving the uniformity of the inside of the porous film, a method of removing an aggregate, contained in a mixture obtained by kneading raw materials of the porous film in the steps (1) and (1′), from the mixture with use of a metal gauze can be employed. It is considered that removable of the aggregate causes an improvement in uniformity of the inside of the porous film obtained and accordingly causes the porous film to be difficult to locally tear, thereby causing an improvement in tear strength of the porous film. Note that the metal gauze preferably has a small mesh size because such a metal gauze allows the aggregate to be less contained in the polyolefin resin composition obtained in the steps (1) and (1′).

By rolling carried out in the steps (2) and (2′), the porous film obtained has a skin layer on the surface thereof. The skin layer is easily damaged by an external impact. Therefore, in a case where the skin layer accounts for a large proportion of the porous film, this causes the porous film to be easily torn and accordingly causes a decrease in tear strength of the porous film. As the method of reducing the proportion of the skin layer accounting for the porous film, a method of using a single-layer sheet in the steps (3) and (3′) can be employed.

It is considered that, in a case where the porous film has a small difference in crystalline orientation between the TD direction and the MD direction, this causes the porous film to have uniform stretch when the porous film is subjected to an external impact, tension, and/or the like and, accordingly, causes the porous film to be difficult to be torn. As the method of reducing the difference in crystalline orientation between the TD direction and the MD direction of the porous film, a method of rolling, in the steps (2) and (2′), the polyolefin resin composition so that a resultant sheet is thick can be employed. In a case where the polyolefin resin composition is rolled so that a resultant sheet is thin, the following result is considered to be brought about. That is, the porous film thus obtained has extremely strong orientation in the MD direction. As a result, although the porous film has high strength with respect to an impact given in the TD direction, the porous film is rapidly torn in an orientation direction (MD direction) once the porous film starts to be torn. In other words, it is considered that, in a case where the polyolefin resin composition is rolled so that a resultant sheet is thick, (i) a rolling speed is increased, (ii) the porous film has less crystalline orientation in the MD direction, (iii) the difference in crystalline orientation between the TD direction and the MD direction becomes small, (iv) the porous film thus obtained is hardly torn rapidly even in a case where the porous film starts to be torn, and accordingly (v) the value A of the tensile elongation of the porous film is improved.

[Pin Extraction Property]

As has been described, the value A of the tensile elongation of the porous film in accordance with an embodiment of the present invention is not less than 0.5 mm, because the difference in crystalline orientation is small between the TD direction and the MD direction. In other words, the porous film in accordance with an embodiment of the present invention is good in balance of the crystalline orientation in the TD direction and the crystalline orientation in the MD direction. This causes the porous film in accordance with an embodiment of the present invention to be good in pin extraction property, which indicates whether a pin is easily extracted from the porous film that has been wound around the pin. Therefore, the nonaqueous electrolyte secondary battery separator, including the porous film, in accordance with an embodiment of the present invention can be suitably used to produce a wound-type secondary battery, having a cylindrical shape, a polygonal shape, or the like, which is produced by an assembling method including the steps of layering a separator, a cathode, and an anode and winding, around a pin, the separator, the cathode, and the anode thus layered.

[Porous Layer]

The nonaqueous electrolyte secondary battery laminated separator in accordance with an embodiment of the present invention includes a porous layer in addition to the porous film. The porous layer is normally a resin layer containing a filler and a resin. The porous layer in accordance with an embodiment of the present invention is preferably a heat-resistant layer or an adhesive layer which is laminated to one side or both sides of the porous film. It is preferable that the resin of which the porous layer is made be insoluble in an electrolyte of a battery and he electrochemically stable in a range of use of the battery. The porous layer that is laminated to one side of the porous film is preferably laminated to a surface of the porous film which surface faces a cathode of a nonaqueous electrolyte secondary battery which includes the nonaqueous electrolyte secondary battery laminated separator, and is more preferably laminated to a surface of the porous film which surface is in contact with the cathode.

Examples of the resin of which the porous layer is made include: polyolefins such as polyethylene, polypropylene, polybutene, and an ethylene-propylene copolymer; fluorine-containing resins such as polyvinylidene fluoride (PVDF) and polytetrafluoroethylene; fluorine-containing rubbers such as a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene tetrafluoroethylene copolymer, and an ethylene-tetrafluoroethylene copolymer; aromatic polyamide; wholly aromatic polyamide (aramid resin); rubbers such as a styrene-butadiene copolymer and a hydride thereof, a methacrylate ester copolymer, an acrylonitrile-acrylic ester copolymer, a styrene-acrylic ester copolymer, ethylene propylene rubber, and polyvinyl acetate; resins having a melting point or a glass transition temperature of not less than 180° C., such as polyphenylene ether, polysulfone, polyether sulfone, polyphenylene sulfide, polyetherimide, polyamide imide, polyether amide, and polyester; water-soluble polymers such as polyvinyl alcohol, polyethylene glycol, cellulose ether, sodium alginate, polyacrylic acid, polyacrylamide, and polymethacrylic acid; and the like.

Specific examples of the aromatic polyamide include poly(paraphenylene terephthalamide), poly(methaphenylene isophthalamide), poly(parabenzamide), poly(methabenzamide), poly(4,4′-benzanilide terephthalamide), poly(paraphenylene-4,4′-biphenylene dicarboxylic amide), poly(methaphenylene-4,4′-biphenylene dicarboxylic amide), poly(paraphenylene-2,6-naphthalene dicarboxylic amide), poly(methaphenylene-2,6-naphthalene dicarboxylic amide), poly(2-chloroparaphenylene terephthalamide), a paraphenylene terephthalamide/2,6-dichloroparaphbenylene terephthalamide copolymer, a methaphenylene terephthalamide/2,6-dichloroparaphenylene terephthalamide copolymer, and the like. Among these aromatic polyamides, poly(paraphenylene terephthalamide) is more preferable.

Among the above resins, a polyolefin, a fluorine-containing resin, an aromatic polyamide, or a water-soluble polymer is more preferable. In a case where the porous layer is provided so as to face a cathode of a nonaqueous electrolyte secondary battery, a fluorine-containing resin is particularly preferable. Use of a fluorine-containing resin makes it easy to maintain various characteristics, such as a rate characteristic and a resistance characteristic (solution resistance), of the nonaqueous electrolyte secondary battery even in a case where a deterioration in acidity occurs while the nonaqueous electrolyte secondary battery is in operation. From the viewpoint of a process and an environmental load, a water-soluble polymer is more preferable because it is possible to use water as a solvent to form the porous layer. Among the above water-soluble polymers, cellulose ether or sodium alginate is further more preferable, and cellulose ether is particularly preferable.

Specific examples of the cellulose ether include carboxymethyl cellulose (CMC), hydroxyethyl cellulose (HEC), carboxy ethyl cellulose, methyl cellulose, ethyl cellulose, cyan ethyl cellulose, oxyethyl cellulose, and the like. Among these cellulose ethers, CMC or HEC, each of which less deteriorates even after a long time period of use and has excellent chemical stability, is more preferable, and CMC is particularly preferable.

The porous layer more preferably contains a filler. Thus, in a case where the porous layer contains a filler, the resin functions also as a binder resin. The filler, which is not particularly limited to any specific filler, can be a filler made of an organic matter or a filler made of an inorganic matter.

Specific examples of the filler made of an organic matter include fillers made of (i) a homopolymer of a monomer such as styrene, vinyl, ketone, acrylonitrile, methyl methacrylate, ethyl methacrylate, glycidyl methacrylate, glycidyl acrylate, or methyl acrylate, or (ii) a copolymer of two or more of such monomers; fluorine-containing resins such as polytetrafluoroethylene, an ethylene tetrafluoride-propylene hexafluoride copolymer, a tetrafluoroethylene-ethylene copolymer, and polyvinylidene fluoride; melamine resin; urea resin; polyethylene; polypropylene; polyacrylic acid and polymethacrylic acid; and the like.

Specific examples of the filler made of an inorganic matter include fillers made of inorganic matters such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, and glass. The porous layer can contain (i) only one kind of filler or (ii) two or more kinds of fillers in combination.

Among the above fillers, a filler made of an inorganic matter is suitable. A filler made of an inorganic oxide such as silica, calcium oxide, magnesium oxide, titanium oxide, alumina, mica, zeolite, aluminum hydroxide, or boehmite is preferable. A filler made of at least one kind selected from the group consisting of silica, magnesium oxide, titanium oxide, aluminum hydroxide, boehmite, and alumina is more preferable. A filler made of alumina is particularly preferable. Alumina has many crystal forms such as α-alumina, β-alumina, γ-alumina, and θ-alumina, and any of the crystal forms can be suitably used. Among the above crystal forms, α-alumina, which is particularly high in thermal stability and chemical stability, is the most preferable.

The filler has a shape that varies depending on, for example, (i) a method for producing the organic matter or inorganic matter as a raw material and (ii) a condition under which the filler is dispersed during preparation of a coating solution for forming the porous layer. The filler can have any of various shapes such as a spherical shape, an oblong shape, a rectangular shape, a gourd shape, and an indefinite irregular shape.

In a case where the porous layer contains a filler, the filler is contained in an amount preferably of 1% by volume to 99% by volume, more preferably of 5% by volume to 95% by volume of the porous layer. The filler which is contained in the porous layer in an amount falling within the above range makes it less likely for a void formed by a contact among fillers to be blocked by, for example, a resin. This makes it possible to obtain sufficient ion permeability and to set a mass per unit area of the porous layer at an appropriate value.

According to an embodiment of the present invention, a coating solution for forming the porous layer is normally prepared by dissolving the resin in a solvent and dispersing the filler in a resultant solution.

The solvent (dispersion medium), which is not particularly limited to any specific solvent, only needs to (i) have no harmful influence on the porous film, (ii) uniformly and stably dissolve the resin, and (iii) uniformly and stably disperse the filler. Specific examples of the solvent (dispersion medium) include; water; lower alcohols such as methyl alcohol, ethyl alcohol, n-propyl alcohol, isopropyl alcohol, and t-butyl alcohol; acetone, toluene, xylene, hexane, N-methylpyrrolidone, N,N-dimethylacetamide, and N,N-dimethylformamide; and the like. The above solvents (dispersion media) can be used in only one kind or in combination of two or more kinds.

The coating solution can be formed by any method, provided that the coating solution can meet conditions such as a resin solid content (resin concentration) and a filler amount each necessary for obtainment of a desired porous layer. Specific examples of a method for forming the coating solution include a mechanical stirring method, an ultrasonic dispersion method, a high-pressure dispersion method, a media dispersion method, and the like.

Further, the filler can be dispersed in the solvent (dispersion medium) by use of, for example, a conventionally publicly known dispersing machine such as a three-one motor, a homogenizer, a media dispersing machine, or a pressure dispersing machine.

In addition, the coating solution can contain, as a component different from the resin and the filler, additive(s) such as a disperser, a plasticizer, a surfactant, and/or a pH adjuster, provided that the additive(s) does/do not impair the object of the present invention. Note that the additive(s) can be contained in an amount that does not impair the object of the present invention.

A method for applying the coating solution to the separator, i.e., a method for forming the porous layer on a surface of the separator which has been appropriately subjected to a hydrophilization treatment is not particularly restricted. In a case where the porous layer is laminated to both sides of the separator, (i) a sequential lamination method in which the porous layer is formed on one side of the separator and then the porous layer is formed on the other side of the separator, or (ii) a simultaneous lamination method in which the porous layer is formed simultaneously on both sides of the separator is applicable to the case.

Examples of a method for forming the porous layer include: a method in which the coating solution is directly applied to the surface of the separator and then the solvent (dispersion medium) is removed; a method in which the coating solution is applied to an appropriate support, the porous layer is formed by removing the solvent (dispersion medium), and thereafter the porous layer thus formed and the separator are pressure-bonded and subsequently the support is peeled off; a method in which the coating solution is applied to the appropriate support and then the porous film is pressure-bonded to an application surface, and subsequently the support is peeled off and then the solvent (dispersion medium) is removed; a method in which the separator is immersed in the coating solution so as to be subjected to dip coating, and thereafter the solvent (dispersion medium) is removed; and the like.

The porous layer can have a thickness that is controlled by adjusting, for example, a thickness of a coated film that is moist (wet) after being coated, a weight ratio between the resin and the filler, and/or a solid content concentration (a sum of a resin concentration and a filler concentration) of the coating solution. Note that it is possible to use, as the support, a film made of resin, a belt made of metal, or a drum, for example.

A method for applying the coating solution to the separator or the support, is not particularly limited to any specific method, provided that the method achieves a necessary mass per unit area and a necessary coating area. The coating solution can be applied to the separator or the support by a conventionally publicly known method. Specific examples of the conventionally publicly known method include a gravure coater method, a small-diameter gravure coater method, a reverse roll coater method, a transfer roll coater method, a kiss coater method, a dip coater method, a knife coater method, an air doctor blade coater method, a blade coater method, a rod coater method, a squeeze coater method, a cast coater method, a bar coater method, a die coater method, a screen printing method, a spray application method, and the like.

Generally, the solvent (dispersion medium) is removed by drying. Examples of a drying method include natural drying, air-blowing drying, heat drying, vacuum drying, and the like. Note, however, that any drying method is usable, provided that the drying method allows the solvent (dispersion medium) to be sufficiently removed. For the drying, it is possible to use an ordinary drying device.

Further, it is possible to carry out the drying after replacing, with another solvent, the solvent (dispersion medium) contained in the coating solution. Examples of a method for removing the solvent (dispersion medium) after replacing the solvent (dispersion medium) with another solvent include a method in which another solvent (hereinafter, referred to as a solvent X) is used that is dissolved in the solvent (dispersion medium) contained in the coating solution and does not dissolve the resin contained in the coating solution, the separator or the support on which a coated film has been formed by application of the coating solution is immersed in the solvent X, the solvent (dispersion medium) contained in the coated film formed on the separator or the support is replaced with the solvent X, and thereafter the solvent X is evaporated. This method makes it possible to efficiently remove the solvent (dispersion medium) from the coating solution.

Assume that heating is carried out so as to remove the solvent (dispersion medium) or the solvent X from the coated film of the coating solution which coated film has been formed on the separator or the support. In this case, in order to prevent the separator from having a lower air permeability due to contraction of pores of the porous film, it is desirable to carry out heating at a temperature at which the separator does not have a lower air permeability, specifically, 10° C. to 120° C., more preferably 20° C. to 80° C.

In a case where the separator is used as the base material to form the laminated separator by laminating the porous layer to one side or both sides of the separator, the porous layer formed by the method described earlier has, per one side thereof, a film thickness preferably of 0.5 μm to 15 μm, more preferably of 2 μm to 10 μm.

The porous layer which has a film thickness of not less than 1 μm (not less than 0.5 μm per one side) makes it possible to sufficiently prevent an internal short circuit due to, for example, breakage of a battery, in the nonaqueous electrolyte secondary battery laminated separator including the porous layer, and such a porous layer is preferable in that the porous layer makes it possible to maintain an amount of an electrolyte retained in the porous layer. Meanwhile, the porous layer whose both sides have a film thickness of not more than 30 μm in total (whose one side has a film thickness of not more than 15 μm) is preferable in that such a porous layer makes it possible to (i) prevent a deterioration, caused in a case where charge and discharge cycles are repeated, in (a) cathode of a nonaqueous electrolyte secondary battery and (b) rate characteristic and/or cycle characteristic, by preventing an increase in permeation resistance of ions such as lithium ions in the entire nonaqueous electrolyte secondary battery laminated separator including the porous layer, and (ii) prevent an increase in size of the nonaqueous electrolyte secondary battery by preventing an increase in distance between the cathode and an anode of the nonaqueous electrolyte secondary battery.

In a case where the porous layer is laminated to both sides of the porous film, physical properties of the porous layer which are described below at least refer to physical properties of the porous layer which is laminated to a surface of the porous film which surface faces the cathode of the nonaqueous electrolyte secondary battery which includes the laminated separator.

The porous layer, which only needs to have, per one side thereof, a mass per unit area which mass is appropriately determined in view of strength, a film thickness, a weight, and handleability of the nonaqueous electrolyte secondary battery laminated separator, normally has a mass per unit area preferably of 1 g/m² to 20 g/m², more preferably of 4 g/m² to 10 g/m² so that the nonaqueous electrolyte secondary battery which includes the nonaqueous electrolyte secondary battery laminated separator as a member can have a higher weight energy density and a higher volume energy density. The porous layer which has a mass per unit area which mass falls within the above range is preferable in that such a porous layer (i) allows the nonaqueous electrolyte secondary battery which includes, as a member, the nonaqueous electrolyte secondary battery laminated separator including the porous layer to have a higher weight energy density and a higher volume energy density, and (ii) allows the nonaqueous electrolyte secondary battery to have a lighter weight.

The porous layer has a porosity preferably of 20% by volume to 90% by volume and more preferably of 30% by volume to 70% by volume in that the nonaqueous electrolyte secondary battery laminated separator including such a porous layer can obtain sufficient ion permeability. Further, the porous layer has pores having a pore size preferably of not more than 1 μm and more preferably of not more than 0.5 μm in that the nonaqueous electrolyte secondary battery laminated separator including such a porous layer can obtain sufficient ion permeability.

The laminated separator has a Gurley air permeability preferably of 30 sec/100 ml to 1000 sec/100 ml and more preferably of 50 sec/100 ml to 800 sec/100 mL. The laminated separator which has a Gurley air permeability falling within the above range makes it possible to obtain sufficient ion permeability in a case where the laminated separator is used as a member for the nonaqueous electrolyte secondary battery.

The laminated separator which has an air permeability falling beyond the above range (specifically, more than 1,000 sec/100 mL) makes it impossible to obtain sufficient ion permeability in a case where the laminated separator is used as a member for the nonaqueous electrolyte secondary battery. This may cause the nonaqueous electrolyte secondary battery to have a lower battery characteristic. Meanwhile, the laminated separator which has an air permeability below the above range (specifically, less than 30 sec/100 mL) means that the laminated separator has a coarse laminated structure due to a high porosity thereof. This causes the laminated separator to have lower strength, so that the laminated separator may he insufficient in shape stability, particularly shape stability at a high temperature.

### Embodiment 3: Nonaqueous Electrolyte Secondary Battery Member

### Embodiment 4: Nonaqueous Electrolyte Secondary Battery

A member for a nonaqueous electrolyte secondary battery (hereinafter referred to as a “nonaqueous electrolyte secondary battery member”) in accordance with Embodiment 3 of the present invention is a nonaqueous electrolyte secondary battery member including a cathode, a nonaqueous electrolyte secondary battery separator in accordance with Embodiment 1 of the present invention or a nonaqueous electrolyte secondary battery laminated separator in accordance with Embodiment 2 of the present invention, and an anode that are provided in this order. A nonaqueous electrolyte secondary battery in accordance with Embodiment 4 of the present invention includes a nonaqueous electrolyte secondary battery separator in accordance with Embodiment 1 of the present invention or a nonaqueous electrolyte secondary battery laminated separator in accordance with Embodiment 2 of the present invention. The following description is given by (i) taking a lithium ion secondary battery member as an example of the nonaqueous electrolyte secondary battery member and (ii) taking a lithium ion secondary battery as an example of the nonaqueous electrolyte secondary battery. Note that components of the nonaqueous electrolyte secondary battery member or the nonaqueous electrolyte secondary battery except the nonaqueous electrolyte secondary battery separator or the nonaqueous electrolyte secondary battery laminated separator are not limited to those discussed in the following description.

In the nonaqueous electrolyte secondary battery in accordance with an embodiment of the present invention, it is possible to use, for example, a nonaqueous electrolyte obtained by dissolving lithium salt in an organic solvent. Examples of the lithium salt include LiClO₄, LiPF₆, LiAsF₆, LiSbF₆, LiBF₄, LiCF₃O₃, LiN(CF₃SO₂)₂, LiC(CF₃SO₂)₃, Li₂B₁₀Cl₁₀, lower aliphatic carboxylic acid lithium salt, LiAlCl₄, and the like. The above lithium salts can be used in only one kind or in combination of two or more kinds. Of the above Lithium salts, at least one kind of fluorine-containing lithium salt selected from the group consisting of LiPF₆, LiAsF₆, LiSbF₆, LiBF₄, LiCF₃SO₃, LiN(CF₃SO₂)₂, and LiC(CF₃SO₂)₃ is more preferable.

Specific examples of the organic solvent of the nonaqueous electrolyte include: carbonates such as ethylene carbonate, propylene carbonate, dimethyl carbonate, diethyl carbonate, ethyl methyl carbonate, 4-trifluoromethyl-1,3-dioxolane-2-one, and 1,2-di(methoxycarbonyloxy)ethane; ethers such as 1,2-dimethoxyethane, 1,3-dimethoxypropane, pentafluoropropylmethyl ether, 2,2,3,3-tetrafluoropropyldifluoromethyl ether, tetrahydrofuran, and 2-methyltetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethylsulfoxide, and 1,3-propanesultone; a fluorine-containing organic solvent obtained by introducing a fluorine group in the organic solvent; and the like. The above organic solvents can be used in only one kind or in combination of two or more kinds. Of the above organic solvents, a carbonate is more preferable, and a mixed solvent of cyclic carbonate and acyclic carbonate or a mixed solvent of cyclic carbonate and an ether is more preferable. The mixed solvent of cyclic carbonate and acyclic carbonate is more preferably exemplified by a mixed solvent containing ethylene carbonate, dimethyl carbonate, and ethyl methyl carbonate. This is because the mixed solvent containing ethylene carbonate, dimethyl carbonate, and ethyl methyl carbonate operates in a wide temperature range, and is refractory also in a case where a graphite material such as natural graphite or artificial graphite is used as an anode active material.

Normally, a sheet cathode in which a cathode current collector supports thereon a cathode mix containing, a cathode active material, an electrically conductive material, and a binding agent is used as the cathode.

Examples of the cathode active material include a material that is capable of doping and dedoping lithium ions. Specific examples of such a material include lithium complex oxides each containing at least one kind of transition metal selected from the group consisting of V, Mn, Fe, Co, and Ni. Of the above lithium complex oxides, a lithium complex oxide having an α-NaFeO₂ structure, such as lithium, nickel oxide or lithium cobalt oxide, or a lithium complex oxide having a spinel structure, such as lithium manganate spinel is more preferable. This is because such a lithium complex oxide is high in average discharge potential. The lithium complex oxide can contain various metallic elements, and lithium nickel complex oxide is more preferable. Further, it is particularly preferable to use lithium nickel complex oxide which contains at least one kind of metallic element so that the at least one kind of metallic element accounts for 0.1 mol % to 20 mol % of a sum of the number of moles of the at least one kind of metallic element and the number of moles of Ni in lithium nickel oxide, the at least one kind of metallic element being selected from the group consisting of Ti, Zr, Ce, Y, V, Cr, Mn, Fe, Co, Cu, Ag, Mg, Al, Ga, In, and Sn. This is because such lithium nickel complex oxide is excellent in cycle characteristic during use of the nonaqueous electrolyte secondary battery at a high capacity. Especially an active material which contains Al or Mn and has an Ni content of not less than 85% and more preferably of not less than 90% is particularly preferable. This is because such an active material is excellent in cycle characteristic during use of the nonaqueous electrolyte secondary battery at a high capacity, the nonaqueous electrolyte secondary battery including the cathode containing the active material.

Examples of the electrically conductive material include carbonaceous materials such as natural graphite, artificial graphite, cokes, carbon black, pyrolytic carbons, carbon fiber, organic high molecular compound baked bodies, and the like. The above electrically conductive materials can be used in only one kind. Alternatively, the above electrically conductive materials can be used in combination of two or more kinds by, for example, mixed use of artificial graphite and carbon black.

Examples of the binding agent include polyvinylidene fluoride, a vinylidene fluoride copolymer, polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-tetrafluoroethylene copolymer, a vinylidene fluoride-trifluoroethylene copolymer, a vinylidene fluoride-trichloroethylene copolymer, and a vinylidene fluoride-vinyl fluoride copolymer, a vinylidene fluoride-hexafluoropropylene-tetrafluoroethylene copolymer, and thermoplastic resins such as thermoplastic polyimide, thermoplastic polyethylene, and thermoplastic polypropylene. Note that the binding agent also functions as a thickener.

The cathode mix can be obtained by, for example, pressing the cathode active material, the electrically Conductive material, and the binding agent on the cathode current collector, or causing the cathode active material, the electrically conductive material, and the binding agent to be in a form of paste by use of an appropriate organic solvent.

Examples of the cathode current collector include electrically conductive materials such as Al, Ni, and stainless steel, and Al, which is easy to process into a thin film and less expensive, is more preferable.

Examples of a method for producing the sheet cathode, i.e., a method for causing the cathode current collector to support the cathode mix include: a method in which the cathode active material, the electrically conductive material, and the binding agent, which are to be formed into the cathode mix are pressure-molded on the cathode current collector; a method in which the cathode current collector is coated with the cathode mix which has been obtained by causing the cathode active material, the electrically conductive material, and the binding agent to be in a form of paste by use of an appropriate organic solvent, and a sheet cathode mix obtained by drying is pressed so as to be closely fixed to the cathode current collector; and the like.

Normally, a sheet anode in which an anode current collector supports thereon an anode mix containing an anode active material is used as the anode.

Examples of the anode active material include a material that is capable of doping and dedoping lithium ions, lithium metal or lithium alloy, and the like. Specific examples of such a material include: carbonaceous materials such as natural graphite, artificial graphite, cokes, carbon black, pyrolytic carbons, carbon fiber, and organic high molecular compound baked bodies; chalcogen compounds such as oxides and sulfides each doping and dedoping lithium ions at a lower potential than that of the cathode; metals such as aluminum (Al), lead (Pb), tin (Sn), bismuth (Bi), and silicon (Si) each alloyed with an alkali metal; cubic intermetallic compounds (AlSb, Mg₂Si, NiSi₂) having lattice spaces in which alkali metals can be provided; lithium nitrogen compounds (Li₃₋ₓMₓN (M: transition metal)); and the Like. Of the above anode active materials, a carbonaceous material which contains, as a main component, a graphite material such as natural graphite or artificial graphite is preferable. This is because such a carbonaceous material is high in potential evenness, and a great energy density can be obtained in a case where the carbonaceous material, which is low in average discharge potential, is combined with the cathode. An anode active material which is a mixture of graphite and silicon and has an Si to C (carbon of the graphite) ratio of not less than 5% is more preferable, and an anode active material which is a mixture of graphite and silicon and has an Si to C (carbon of the graphite) ratio of not less than 10% is still more preferable.

The anode mix can be obtained by, for example, pressing the anode active material on the anode current collector, or causing the anode active material to be in a form of paste by use of an appropriate organic solvent.

Examples of the anode current collector include Cu, Ni, stainless steel, and the like, and Cu, which is difficult to alloy with lithium particularly in a lithium ion secondary battery and easy to process into a thin film, is more preferable.

Examples of a method for producing the sheet anode, i.e., a method for causing the anode current collector to support the anode mix include: a method in which the anode active material to be formed into the anode mix is pressure-molded on the anode current collector; a method in which the anode current collector is coated with the anode mix which has been obtained by causing the anode active material to be in a form of paste by use of an appropriate organic solvent, and a sheet anode mix obtained by drying is pressed so as to be closely fixed to the anode current collector; and the like.

The nonaqueous electrolyte secondary battery member in accordance with an embodiment of the present invention is formed by providing the cathode, the nonaqueous electrolyte secondary battery separator in accordance with Embodiment 1 of the present invention or the nonaqueous electrolyte secondary battery laminated separator in accordance with Embodiment 2 of the present invention, and the anode in this order. Thereafter, the nonaqueous electrolyte secondary battery member is placed in a container serving as a housing of the nonaqueous electrolyte secondary battery. Subsequently, the container is filled with a nonaqueous electrolyte, and then the container is sealed while being decompressed. The nonaqueous electrolyte secondary battery in accordance with an embodiment of the present invention can thus be produced. The nonaqueous electrolyte secondary battery, which is not particularly limited in shape, can have any shape such as a sheet (paper) shape, a disc shape, a cylindrical shape, or a prismatic shape such as a rectangular prismatic shape. Note that a method for producing the nonaqueous electrolyte secondary battery is not particularly limited to any specific method, and a conventionally publicly known production method can be employed as the method.

The nonaqueous electrolyte secondary battery in accordance with an embodiment of the present invention includes, as the nonaqueous electrolyte secondary battery separator, a porous film containing a polyolefin, the porous film having tear strength of not less than 1.5 mN/μm, the tear strength being measured by the Elmendorf tear method (in conformity with JIS K 7128-2), in measurement carried out by the Elmendorf tear method, a direction in which the porous film is torn being a TD direction, the porous film exhibiting tensile elongation of a value A of not less than 0.5 mm from a time point when a load reaches a maximum load to a time point when the load decreases to 25% of the maximum load, according to a load-tensile elongation curve obtained by measuring tear strength of the porous film by the right angled tear method (in conformity with JIS K 7128-3), in measurement carried out by the right angled tear method, a direction in which the porous film is stretched being an MD direction, and a direction in which the porous film is torn being the TD direction. Alternatively, the nonaqueous electrolyte secondary battery in accordance with an embodiment of the present invention includes the nonaqueous electrolyte secondary battery laminated separator including the porous film and the foregoing porous layer. The nonaqueous electrolyte secondary battery in accordance with an embodiment of the present invention is thus arranged such that, even when the nonaqueous electrolyte secondary battery is given an external impact, an internal short circuit does not easily occur and sudden occurrence of a serious internal short circuit is suppressed. Therefore, the nonaqueous electrolyte secondary battery is greatly safe. Similarly, the nonaqueous electrolyte secondary battery member in accordance with an embodiment of the present invention can be suitably used to produce a greatly safe nonaqueous electrolyte secondary battery.

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

### EXAMPLES

### Method of Measuring Physical Properties

Physical properties of a nonaqueous electrolyte secondary battery separator (porous film) produced in each of Examples 1 and 2 and Comparative Examples 1 and 2 below were measured by the following methods.

(a) Tear Strength Measured by Elmendorf Tear Method

Tear strength of the porous film was measured in accordance with “JIS K 7128-2 Plastics-Film and sheeting-Determination of tear resistance—Part 2: Elmendorf method.” A measurement device and measurement conditions used were as follows:

Device: digital Elmendorf tear tester (manufactured by Toyo Seiki Seisaku-Sho, SA-WP type);

Sample size: specimen form, having a rectangular shape, based on the Japanese Industrial Standards;

Conditions: swing angle of 68.4 degrees, the number of times of measurement n=5; and

A sample used for evaluation was cut out from the porous film, to be subjected to measurement, so that a direction in which the sample was to be torn during the measurement was at a right angle with respect to a direction in which the porous film had been conveyed during preparation of the porous film (hereinafter, a direction of the right angle will be referred to as a TD direction). Further, the measurement was carried out in a state where four through eight samples of the porous film were layered, and a value of a tear load thus measured was divided by the number of the samples so as to calculate tear strength of each of the samples. Thereafter, by dividing the tear strength of the each of the samples by a thickness of the each of the samples, tear strength T per micrometer of a thickness of the porous film was calculated.

Specifically, the tear strength T was measured in accordance with the following expression:

T=(F/d)

where: T denotes tear strength (mN/μm);

F denotes a tear load (mN/film); and

d denotes a film thickness (μm/film).

An average of tear strength obtained at five points by carrying out the measurement five times was assumed to be true tear strength (note, however, that data deviated from the average by plus or minus 50% or more was eliminated from calculation).

(b) Value A of Tensile Elongation Based on Right Angled Tear Method

Tear strength of the porous film was measured in accordance with “JIS K 7128-3 Plastics-Film and sheeting-Determination of tear resistance—Part 3: Right angled tear method,” and a load-tensile elongation curve was created. A value A of tensile elongation of the porous film was then calculated from the load-tensile elongation curve. A measurement device and measurement conditions used to measure the tear strength by the right angled tear method were as follows:

Device: universal testing machine (manufactured by INSTRON, 5582 type);

Sample size: specimen form based on the Japanese Industrial Standards;

Conditions: tension speed of 200 mm/min, the number of times of measurement n=5 (note, however, that measurement in which data deviated from an average by plus or minus 50% or more was obtained was eliminated); and

A sample used for evaluation was cut out so that a direction in which the sample was to be torn was a TD direction. That is, the sample was cut out so as to become longer in an MD direction than in the TD direction.

From the load-tensile elongation curve created from a result of the above measurement, the value A (mm) of the tensile elongation from a time point when a load reached a maximum load to a time point when the load decreased to 25% of the maximum load was calculated by the following method.

A load-tensile elongation curve was created, and a maximum load (load at a time point when the sample started to be torn) was assumed to be X (N). A value obtained by multiplying X (N) by 0.25 was assumed to be Y (N). Further, a value of tensile elongation from a time point when the load reached X to a time point when the load decreased to Y was assumed to be A₀ (mm) (see FIG. 1). An average of A₀ (mm) obtained at five points by carrying out the measurement five times was assumed to be A (mm) (note, however, that data deviated from the average by plus or minus 50% or more was eliminated from calculation).

(c) Measurement of Test Force Which Caused Dielectric Breakdown

A test force which caused a dielectric breakdown was measured by a simple electrical conduction test by nail penetration (hereinafter, referred to as a nail penetration electrical conduction test), with use of a measurement device (described below) for a nail penetration electrical conduction test. Note that a piece cut out, from the porous film obtained in each of Examples and Comparative Examples, so as to have a size of 5 mm×5 mm was used as a separator (porous film) in the nail penetration electrical conduction test.

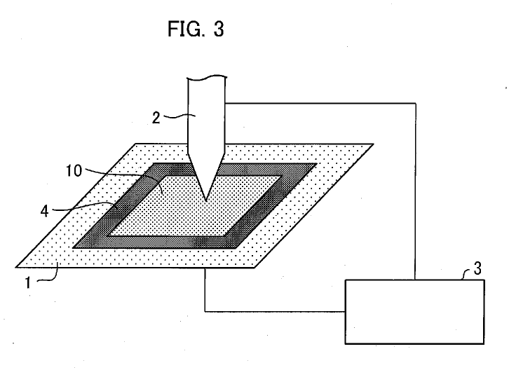

First, the measurement device for a nail penetration electrical conduction test will be described below with reference to FIG. 3.

As illustrated in FIG. 3, the measurement device for a nail penetration electrical conduction test, that is, the measurement device for measuring a test force which causes a dielectric breakdown of a separator is made tip of: an SUS plate (SUB304; having a thickness of 1 mm) serving as a base on which a separator (porous film) to be measured is placed; a drive section (not illustrated) which holds a nail of N50 specified in JIS A 5508 and which moves up and down, at a constant speed, the nail thus held; a resistance measurement device which measures a direct current resistance between the hail and the SUS plate; and a material test machine (not illustrated) which measures an amount of deformation of the separator in a thickness direction of the separator and which measures a force required for the deformation. In Examples and Comparative Examples, the SUS plate had a size at least larger than that of the separator. Specifically, the SUS plate had a size of 15.5 mm φ. The drive section, which is provided above the SUS plate, holds the nail so that a tip of the nail is perpendicular to a surface of the SUS plate, and vertically moves the nail thus held. In Examples and Comparative Examples, as the resistance measurement device, a commercially-available device “Digital Multimeter 7461P (manufactured by ADC CORPORATION)” was used. As the material test machine, a commercially-available machine “Compact Table-Top Universal Tester EZTest EZ-L (manufactured by SHIMADZU CORPORATION)” was used.

The test force which caused the dielectric breakdown of the separator (porous film) was measured as below with use of the above measurement device.

First, the nail was fixed, with use of a drill chuck fixture, to a load cell provided in a crosshead of the drive section of the material test machine. Further, a fixing base was placed on a surface of a lower part of the material test machine to which surface the fixture was attached, an anode sheet serving as an anode of a non-aqueous electrolyte secondary battery was placed on the SUS plate located on the fixing base, and the separator was placed on the anode sheet. An amount of deformation of the separator in a thickness direction of the separator was measured with use of a stroke of the crosshead of the material test machine, and a force required for the deformation was measured with use of the load cell to which the nail was fixed. Then, the nail and the resistance measurement device were electrically connected, and the SUS plate and the resistance measurement device were electrically connected. Note that such an electrical connection was made with use of an electric cord and a crocodile clip.

Note that the anode sheet used in the above measurement was prepared by a method including the following steps of:

(i) adding, to 98 parts by weight of graphite powder serving as an anode active material, 100 parts by weight of an aqueous solution of carboxy methyl cellulose serving as a thickener and a binding agent (a concentration of carboxymethyl cellulose; 1% by weight) and 2 parts by weight of an aqueous emulsion of styrene-butadiene rubber (a concentration of styrene-butadiene rubber; 50% by weight), mixing those components together, and then further adding 22 parts by weight of water to a resultant mixture, to prepare a slurry having a solid content concentration of 45% by weight;

(ii) applying the slurry, obtained in the step (i), to part of rolled copper foil serving as an anode current collector and having a thickness of 20 μm, drying the slurry so that the slurry had a basis weight of 140 g/m², and then rolling the rolled copper foil with use of a pressing machine so that the rolled copper foil had a thickness of 120 μm (an anode active material layer had a thickness of 100 μm); and

(iii) cutting the rolled copper foil, obtained in the step (ii), so that part of the rolled copper foil in which part the anode active material layer was formed had a size of 7 mm×7 mm, to prepare the anode sheet for the nail penetration electrical conduction test.

Next, the drive section was driven to move down the nail and then to stop moving down the nail so that the tip of the nail was in contact with a surface (uppermost layer) of the separator (completion of preparation for the measurement). Then, a state where the tip of the nail was in contact with the surface of the separator was regarded as a displacement “0” in the thickness direction of the separator.

After the preparation for the measurement was completed, the driving section was driven to start moving down, the nail at a descending speed of 50 μm/min. Simultaneously with this, the amount of the deformation of the separator in the thickness direction of the separator and the force required for the deformation were measured by use of the material testing machine, and a direct current resistance between the nail and the SUS plate was measured with use of the resistance measurement device. After a start of the measurement, a time point when the direct current resistance reached not more than 10,000Ω first was regarded as a dielectric breakdown point. Then, a test force (unit: N), i.e., a measuring force which caused a dielectric breakdown was calculated from the amount of the deformation in the thickness direction of the separator at the dielectric breakdown point. Furthermore, by dividing the test force by a film thickness of the separator, the test force (N/μm) which caused the dielectric breakdown was calculated.

Note that, in a case where a value of a test force (N/μm) which is calculated by the above method and which causes a dielectric breakdown is high, specifically, in a ease where the value of the test force is not less than 0.12 N/μm, this means that an electrical insulation property of such a separator is retained even when the separator is locally given an impact externally caused by an foreign substance or deformation. For this reason, in a case where such a separator is used for a nonaqueous electrolyte secondary battery, the separator makes it possible to prevent sudden occurrence of an internal short circuit caused by, for example, breakage of the nonaqueous electrolyte secondary battery, that is, such a nonaqueous electrolyte secondary battery separator (porous film) allows the nonaqueous electrolyte secondary battery to be greatly safe.

(d) Pin Extraction Evaluation Test

The nonaqueous electrolyte secondary battery separator (porous film) obtained in each of Examples and Comparative Examples was cut into a piece having a size of 62 mm in the TD direction×30 cm in the MD direction, and the piece (i.e., separator) was wound around a stainless steel rule (manufactured by Shinwa Rules Co., Ltd, Item No.: 13131) five times while a weight of 300 g was being attached to the piece. In so doing, the separator was wound around the stainless steel rule so that the TD direction of the separator was in parallel to a longitudinal direction of the stainless steel rule. The stainless steel rule was then extracted at a speed of approximately 8 cm/sec. Before and after the stainless steel was extracted, a width, in the TD direction, of part of the separator which part was/had been wound around the stainless steel rule five times was measured with use of a slide caliper so as to calculate an amount of a change (mm) in width. The amount of the change indicates an amount of elongation of the separator in a direction in which the stainless steel rule was extracted, the elongation resulting from a fact that (i) part of the separator which part started to be wound around the stainless steel rule was moved, due to a friction force between the stainless steel rule and the separator, in the direction in which the stainless steel rule was extracted and (ii) the separator was accordingly shaped into a helical shape.

Furthermore, how easily the stainless steel rule had been extracted was also examined. Specifically, a case where the stainless steel rule had been extracted smoothly without a sense of resistance was evaluated as “Good.” A case where the stainless steel rule had been extracted with a slight sense of resistance was evaluated as “Fair.” A case where the stainless steel rule had been extracted with a sense of resistance and had been difficult to extract was evaluated as “Poor.” Note that the stainless steel rule had a bent part at its one end in the longitudinal direction, and the stainless steel rule was extracted in a direction in which the bent part was formed.

Note that an amount of elongation of a separator, which amount is calculated by the above method, is preferably less than 0.2 mm, more preferably not more than 0.15 mm, still more preferably not more than 0.1 mm. In a case where the separator has a poor pin extraction property, a force may concentrate between a base material and a pin while the pin is being extracted during production of a battery. This may cause breakage of the separator. In a case where the amount of the elongation of the separator is large, the separator and an electrode may be misaligned during the production of the battery. This may cause trouble with the production.

### Example 1

First, 68.5% by weight of ultrahigh-molecular-weight polyethylene powder (GUR4032, manufactured by Ticona) and 31.5% by weight of polyethylene wax (FNP-0115, manufactured by Nippon Seiro Co., Ltd.) having a weight average molecular weight of 1,000 were prepared. That is, 100 parts by weight, in total, of the ultrahigh-molecular-weight polyethylene powder and the polyethylene wax were prepared. To the ultrahigh-molecular-weight polyethylene powder and the polyethylene wax, 0.4% by weight of an antioxidant (Irg1010, manufactured by Ciba Specialty Chemicals), 0.1% by weight of another antioxidant (P168, manufactured by Ciba Specialty Chemicals), and 1.3% by weight of sodium stearate were added. Further, calcium carbonate (manufactured by Maruo Calcium Co., Ltd.) having an average particle size of 0.1 μm was added so that the calcium carbonate accounted for 36% by volume of a total volume of all these compounds. The compounds were mixed in a state of powder with use of a Henschel mixer, melt-kneaded with use of a twin screw kneading extruder, and then caused to pass through a 300-mesh metal gauze, to obtain a polyolefin resin composition. The polyolefin resin composition was rolled with use of a pair of rollers each having a surface temperature of 150° C., and cooled in stages while being stretched with use of other rollers rotating at a speed different from that of the pair of rollers, to prepare a single-layer sheet having a draw ratio (a winding roller speed/a reduction roller speed) of 1.4 times.

The single-layer sheet was immersed in an aqueous hydrochloric solution (in which 4 mol/L of hydrochloric acid and 0.5% by weight of a non-ionic surfactant were blended) so that the calcium carbonate was removed. Subsequently, the single-layer sheet was stretched by 7.0 times at 100° C. to obtain a porous film (1). Note that Table 1 shows the above raw materials, production conditions, and the like.

Next, physical properties of the porous film (1) were measured by carrying out the foregoing measurements (a) through (d). Table 2 shows results of the measurements.

### Example 2

First, 70.0% by weight of ultrahigh-molecular-weight polyethylene powder (GUR4032, manufactured by Ticona) and 30.0% by weight of polyethylene wax (FNP-0115, manufactured by Nippon Seiro Co., Ltd.) having a weight average molecular weight of 1,000 were prepared. That is, 100 parts by weight, in total, of the ultrahigh-molecular-weight polyethylene powder and the polyethylene wax were prepared. To the ultrahigh-molecular-weight polyethylene powder and the polyethylene wax, 0.4% by weight of an antioxidant (Irg1010, manufactured by Ciba Specialty Chemicals), 0.1% by weight of another antioxidant (P168, manufactured by Ciba Specialty Chemicals), and 1.3% by weight of sodium stearate were added. Further, calcium carbonate (manufactured by Maruo Calcium Co., Ltd.) having an average particle size of 0.1 μm was added so that the calcium carbonate accounted for 36% by volume of a total volume of all these compounds. The compounds were mixed in a state of powder with use of a Henschel mixer, melt-kneaded with use of a twin screw kneading extruder, and then caused to pass through a 200-mesh metal gauze, to obtain a polyolefin resin composition. The polyolefin resin composition was rolled with use of a pair of rollers each having a surface temperature of 150° C., and cooled in stages while being stretched with use of other rollers rotating at a speed different from that of the pair of rollers, to prepare a single-layer sheet having a draw ratio (a winding roller speed/a reduction roller speed) of 1.4 times and having a film thickness of approximately 41 μm. Next, in a similar manner, a single-layer sheet having a draw ratio of 1.2 times and having a film thickness of approximately 68 μm was prepared. Those single-layer sheets thus obtained were pressure-bonded to each other with rise of a pair of rollers each having a surface temperature of 150° C. A laminated sheet was thus prepared.

The laminated sheet was immersed in an aqueous hydrochloric solution (in which 4 mol/L of hydrochloric acid and 0.5% by weight of a non-ionic surfactant were blended) so that the calcium carbonate was removed. Subsequently the laminated sheet was stretched by 6.2 times at 105° C. to obtain a porous film (2), Note that Table 1 shows the above raw materials, production conditions, and the like.

Next, physical properties of the porous film (2) were measured by carrying out the foregoing measurements (a) through (d). Table 2 shows results of the measurements.

### Comparative Example 1

First, 70.0% by weight of ultrahigh-molecular-weight polyethylene powder (GUR4032, manufactured by Ticona) and 30.0% by weight of polyethylene wax (FNP-0115, manufactured by Nippon Seiro Co., Ltd.) having a weight average molecular weight of 1,000 were prepared. That is, 100 parts by weight, in total, of the ultrahigh-molecular-weight polyethylene powder and the polyethylene wax were prepared. To the ultrahigh-molecular-weight polyethylene powder and the polyethylene wax, 0.4% by weight of an antioxidant (Irg1010, manufactured by Ciba Specialty Chemicals), 0.1% by weight of another antioxidant (P168, manufactured by Ciba Specialty Chemicals), and 1.3% by weight of sodium stearate were added. Further, calcium carbonate (manufactured by Maruo Calcium Co., Ltd.) having an average particle size of 0.1 μm was added so that the calcium carbonate accounted for 36% by volume of a total volume of all these compounds. The compounds were mixed in a state of powder with use of a Henschel mixer, melt-kneaded with use of a twin screw kneading extruder, and then caused to pass through a 200-mesh metal gauze, to obtain a polyolefin resin composition. The polyolefin resin composition was roiled with use of a pair of rollers each having a surface temperature of 150° C., and cooled in stages while being stretched with use of other rollers rotating at a speed different from that of the pair of rollers, to prepare a single-layer sheet, having a draw ratio (a winding roller speed/a reduction roller speed) of 1.4 times and having a film thickness of approximately 29 μm. Next, in a similar manner, a single-layer sheet having a draw ratio of 1.2 times and having a film thickness of approximately 50 μm was prepared. Those single-layer sheets thus obtained were pressure-bonded to each other with use of a pair of rollers each having a surface temperature of 150° C. A laminated sheet was thus prepared.

The laminated sheet was immersed in an aqueous hydrochloric solution fin which 4 mol/L of hydrochloric acid and 0.5% by weight of a non-ionic surfactant were blended) so that the calcium carbonate was removed. Subsequently, the laminated sheet was stretched by 6.2 times at 105° C. to obtain a porous film (3). Note that Table 1 shows the above raw materials, production conditions, and the like.

Next, physical properties of the porous film (3) were measured by carrying out the foregoing measurements (a) through (d). Table 2 shows results of the measurements.

### Comparative Example 2

A commercially-available porous film (polyolefin separator, having a film thickness of 25.4 μm) was regarded as a porous film (4). Next, physical properties of the porous film (4) were measured by carrying out the foregoing measurements (a) through (d). Table 2 shows results of the measurements.

TABLE 1

| | | | | Composition Ratio | | | | |
|---|---|---|---|---|---|---|---|---|
| | | | | | Calcium | | | |
| | | | | | Carbonate | | | |
| | Porous | Composition | | WAX Ratio | Ratio | Stretching Condition | | |
| | Film | PE | WAX | (% by weight) | (% by volume) | Temperature | Magnification | Others |
| Example 1 | Porous | GUR | FNP | 31.5 | 36.0 | 100 | 7.0 | Rolling (draw ratio |
| | Film (1) | 4032 | 0115 | | | | | of 1.4 times) + |
| | | | | | | | | granulation with |
| | | | | | | | | 300 mesh |
| Example 2 | Porous | GUR | FNP | 30.0 | 36.0 | 105 | 6.2 | Lamination rolling |
| | Film (2) | 4032 | 0115 | | | | | (draw ratio of 1.4 |
| | | | | | | | | times and |
| | | | | | | | | thickness of |
| | | | | | | | | 41 μm × |
| | | | | | | | | draw ratio of |
| | | | | | | | | 1.2 times and |
| | | | | | | | | thickness of |
| | | | | | | | | 68 μm) + |
| | | | | | | | | granulation |
| | | | | | | | | with 200 mesh |
| Comparative | Porous | GUR | FNP | 30.0 | 36.0 | 105 | 6.2 | Lamination rolling |
| Example 1 | Film (3) | 4032 | 0115 | | | | | (draw ratio of 1.4 |
| | | | | | | | | times and |
| | | | | | | | | thickness of |
| | | | | | | | | 29 μm × |
| | | | | | | | | draw ratio of |
| | | | | | | | | 1.2 times and |
| | | | | | | | | thickness of |
| | | | | | | | | 50 μm) + |
| | | | | | | | | granulation |
| | | | | | | | | with 200 mesh |

TABLE 2

| | | | | | | Test Force Causing | | | |
|---|---|---|---|---|---|---|---|---|---|
| | | | | Tear Strength | Value A of | Dielectric Breakdown | | Pin Extraction | |
| | | Film | | (TD Direction) | Tensile | (N/μm) | | Evaluation | |
| | Porous | Thickness | Porosity | (Elmendorf) | Elongation | Numerical | | Numerical | |
| | Film | (μm) | (%) | (mN/μm) | (mm) | Value | Evaluation | Value | Elongation |
| Example 1 | Porous | 11.1 | 39 | 2.7 | 0.5 | 0.17 | Good | 0.05 | Good |
| | Film (1) | | | | | | | | |
| Example 2 | Porous | 15.6 | 53 | 1.9 | 0.5 | 0.13 | Good | 0.06 | Good |
| | Film (2) | | | | | | | | |
| Comparative | Porous | 16.3 | 65 | 1.4 | 0.6 | 0.11 | Poor | 0.21 | Poor |
| Example 1 | Film (3) | | | | | | | | |
| Comparative | Porous | 25.4 | 53 | 4.8 | 0.2 | 0.07 | Poor | 0.35 | Poor |
| Example 2 | Film (4) | | | | | | | | |

In Table 2, evaluation of the test force which caused the occurrence of the dielectric breakdown was made as follows. That is, a case where the test force was not less than 0.12 N/μm was evaluated as “Good,” and a ease where the test force was less than 0.12 N/μm was evaluated as “Poor.” Further, the pin extraction evaluation was made as follows. That is, a case where a difference in width of the separator between before and after the stainless steel rule was extracted was not more than 0.1 mm was evaluated as “Good,” a case where the difference was more than 0.1 mm and less than 0.2 mm was evaluated as “Fair” and a case where the difference was not less than 0.2 mm was evaluated as “Poor.”

### CONCLUSION

From Table 2, the following points were found. According to the nonaqueous electrolyte secondary battery separator (porous film), in accordance with an embodiment of the present invention, which was prepared in each of Examples 1 and 2, the tear strength based on the Elmendorf tear method was not less than 1.5 mN/μm, the value A of the tensile elongation was not less than 0.5 mm, and the test force which caused the occurrence of the dielectric breakdown was not less than 0.12 N/μm. According to the nonaqueous electrolyte secondary battery separator (porous film) which was prepared in each of Comparative Examples, the tear strength and the value A of the tensile elongation were both lower, and the test force which caused the occurrence of the dielectric breakdown was less than 0.12 N/μm. This indicated that the nonaqueous electrolyte secondary battery separator in accordance with an embodiment of the present invention made it possible to prevent sudden occurrence of an internal short circuit caused by, for example, breakage of a battery, that is, indicated that the nonaqueous electrolyte secondary battery separator in accordance with an embodiment of the present invention allowed a battery to be greatly safe.

It was also found that the tear strength based on the Elmendorf tear method became lower in order of Example 1, Example 2, and Comparative Example 1. From a comparison between Examples 1 and 2, the following points were considered. That is, the nonaqueous electrolyte secondary battery separator (porous film) prepared in Example 2 was a film obtained by stretching the laminated sheet. Meanwhile, the porous film prepared in Example 1 was a film obtained by stretching the single-layer sheet. Therefore, the film obtained by stretching the laminated sheet had a larger proportion of a skin layer and was, accordingly, slightly more easily torn than the film obtained by stretching the single-layer sheet. Meanwhile, the nonaqueous electrolyte secondary battery separator (porous film) prepared in Comparative Example 1 was a film obtained by stretching the laminated sheet made up of the single-layer sheets each of which was thinner than each of the single-layer sheets used in Example 2. Therefore, the porous film prepared in Comparative Example 1 had a still larger proportion of a skin layer and was, accordingly, poorer in balance of crystalline orientation in the MD direction and crystalline orientation in the TD direction, so that the porous film prepared in Comparative Example 1 was still more easily torn.

The nonaqueous electrolyte secondary battery separator (porous film) prepared in Comparative Example 2 was high in tear strength based on the Elmendorf tear method in the TD direction, while the nonaqueous electrolyte secondary battery separator prepared in Comparative Example 2 was low in value A of the tensile elongation. From a comparison between Examples and Comparative Example 2, the following points were considered. That is, the porous film which had strong orientation in the MD direction had high strength with respect to an impact given in the TD direction. However, since the porous film had strong orientation in the MD direction and was thus poor in balance of the crystalline orientation in the MD direction and the crystalline orientation in the TD direction, the porous film was rapidly torn in an orientation direction once the porous film started to be torn.

From a result of the pin extraction evaluation carried out in each of Examples 1 and 2 and Comparative Examples 1 and 2, it was found that the nonaqueous electrolyte secondary battery separator (porous film) prepared in each of Examples 1 and 2 was more excellent in pin extraction property than that prepared in each of Comparative Examples 1 and 2. This was considered to be because, since the porous film prepared in each of Examples was better in balance of the crystalline orientation in the MD direction and the crystalline orientation in the TD direction, slidability between the nonaqueous electrolyte secondary battery separator and the pin was better and, accordingly, the nonaqueous electrolyte secondary battery separator prepared in each of Examples was more excellent in pin extraction property. It was found, from the above results, that the nonaqueous electrolyte secondary battery separator, in accordance with an embodiment of the present invention, which was prepared in each of Examples 1 and 2 could be suitably used to produce a wound-type secondary battery, having a cylindrical shape, a polygonal shape, or the like, which was produced by an assembling method including the steps of layering a separator, a cathode, and an anode and winding, around a pin, the separator, the cathode, and the anode thus layered.

### INDUSTRIAL APPLICABILITY

Each of the nonaqueous electrolyte secondary battery separator in accordance with an embodiment of the present invention and the nonaqueous electrolyte secondary battery laminated separator in accordance with an embodiment of the present invention causes an internal short circuit not to easily occur, even when being given an external impact, and accordingly can be used to produce a nonaqueous electrolyte secondary battery in which sudden occurrence of a serious internal short circuit is suppressed and which is therefore greatly safe.

### REFERENCE SIGNS LIST

1 SUS plate

2 Nail

3 Resistance measurement device

4 Anode sheet

10 Porous film

1. A nonaqueous electrolyte secondary battery separator comprising a porous film containing a polyolefin-based resin which accounts for not less than 50% by volume of the porous film,
the nonaqueous electrolyte secondary battery separator having tear strength of not less than 1.5 mN/μm, the tear strength being measured by the Elmendorf tear method (in conformity with JIS K 7128-2),
in measurement carried out by the Elmendorf tear method, a direction in which the porous film is torn being a TD direction,
the nonaqueous electrolyte secondary battery separator exhibiting tensile elongation of a value A of not less than 0.5 mm from a time point when a load reaches a maximum load to a time point when the load decreases to 25% of the maximum load, according to a load-tensile elongation curve obtained by measuring tear strength of the nonaqueous electrolyte secondary battery separator by the right angled tear method (in conformity with JIS K 7128-3),
in measurement carried out by the right angled tear method, a direction in which the porous film is stretched being an MD direction, and a direction in which the porous film is torn being the TD direction.

2. A nonaqueous electrolyte secondary battery laminated separator comprising:
a nonaqueous electrolyte secondary battery separator recited in claim 1; and
a porous layer.

3. A nonaqueous electrolyte secondary battery member comprising:
a cathode;
a nonaqueous electrolyte secondary battery separator recited in claim 1; and
an anode,
the cathode, the nonaqueous electrolyte secondary battery separator, and the anode being provided in this order.

4. A nonaqueous electrolyte secondary battery member comprising:
a cathode;
a nonaqueous electrolyte secondary battery laminated separator recited in claim 2; and
an anode,
the cathode, the nonaqueous electrolyte secondary battery laminated separator, and the anode being provided in this order.

5. A nonaqueous electrolyte secondary battery comprising:
a nonaqueous electrolyte secondary battery separator recited in claim 1.

6. A nonaqueous electrolyte secondary battery comprising: a nonaqueous electrolyte secondary battery laminated separator recited in claim 2.
